(19) United States
(12) Patent Application Publication
(10) Pub. No.: US 2011/0069967 A1
(43) Pub. Date: Mar. 24, 2011

(54) Standardized Identification of Pluggable Optics

(76) Inventor: Stephen Howard Culpepper, Sharpsburg, GA (US)

(21) Appl. No.: 12/566,112

(22) Filed: Sep. 24, 2009

(51) Int. Cl. H04B 10/00; G02B 6/36

(52) U.S. Cl. 398/139; 385/92

(57) ABSTRACT

Described herein are devices, assemblies, and systems for standardized identification of pluggable device, such as pluggable optics or small form-factor pluggable (“SFP”) transceivers. Specifically, the exemplary embodiments provide visual identification of operating properties for various pluggable devices without removing the devices from service and without the aid of software identification techniques. An exemplary assembly comprises a housing including an inserted portion and an exposed portion, a printed circuit board attached within the housing, at least one electrical contact connected to the printed circuit board and attached to the inserted portion providing an electrical connection to a host device, at least one optical contact connected to the printed circuit board and attached to the exposed portion providing an optical connection to an optical device, and a visual indicator displayed on the exposed portion representing at least one characteristic of the device.

### BACKGROUND

A small form-factor pluggable (“SFP”) may be described as a compact, “pluggable” transceiver used for both telecommunication and data communications applications. An SFP may interface a network device motherboard, such as for a switch, router, media converter, etc., to a fiber optic or copper networking cable. SFP transceivers may be designed to support various protocols, such as SONET, Gigabit Ethernet, and other communications standards. The use of SFPs is expanding to SFP+ that will be able to support data rates up to 10.0 Gbit/s and include the data rates for 10 GbE.

Accordingly, pluggable optics are becoming increasingly popular as an industry format, and it is now supported by several network component vendors. However problems have come up in allowing users to identify specific details of these devices. Once pluggable optics are installed, only a very small physical area remains exposed to the users. Unfortunately, the labeling that identifies the specific details of the optics is not visible. Typically, products that utilize pluggable optics allow the user to identify the installed optics through the assistance of software and graphical user interface (“GUI”). However, some devices and pluggables are not sophisticated enough to include this level of intelligence. Accordingly, there needs to be standardization for easily and universal identifying pluggable optics to its users.

### SUMMARY OF THE INVENTION

Described herein are devices, assemblies, and systems for standardized identification of pluggable device, such as pluggable optics or small form-factor pluggable (“SFP”) transceivers. Specifically, the exemplary embodiments provide visual identification of operating properties for various pluggable devices without removing the devices from service and without the aid of software identification techniques.

One embodiment relates to assembly comprises a housing including an inserted portion and an exposed portion, a printed circuit board attached within the housing, at least one electrical contact connected to the printed circuit board and attached to the inserted portion providing an electrical connection to a host device, at least one optical contact connected to the printed circuit board and attached to the exposed portion providing an optical connection to an optical device, and a visual indicator displayed on the exposed portion representing at least one characteristic of the device.

A another embodiment relates to a transceiver system, comprising a housing means including an inserted portion and an exposed portion, an electrical connecting means connecting the inserted portion to a host device, an optical connecting means connecting the exposed portion to an optical device, and a visual indicating means on the exposed portion representing at least one characteristic of the device.

A further embodiment relates to an optical receptacle, comprising an optical contact connecting the optical receptacle to an optical component, an electrical contact connected the optical receptacle to a pluggable optics device, and at least one visual indicator including one of a color-coded scheme and a patterned scheme, the at least one visual indicator describing at least one characteristic of the pluggable optics device

### BRIEF DESCRIPTION OF THE DRAWINGS

FIG. 1 shows an exemplary assembly for standardized identification of pluggable optics according to an exemplary embodiment.

FIGS. 2A-2C show various configurations for the visual indicators of a pluggable optics device according to an exemplary embodiment.

### DETAILED DESCRIPTION

The exemplary embodiments of the disclosure may be further understood with reference to the following description and the related appended drawings, wherein like elements are provided with the same reference numerals. The exemplary embodiments of the application are related to devices, assemblies, systems and methods for standardized identification of pluggable device, such as pluggable optics or small form-factor pluggable (“SFP”) transceivers. Specifically, the exemplary embodiments are related to systems and methods for providing visual identification of the operating properties for various pluggable devices without removing the devices from service and without the aid of software identification techniques.

It should be noted that this disclosure relates to all types of pluggable optics devices within any type of applications, such as for example, telecommunication and data communications applications. An exemplary SFP transceiver may interface a network device motherboard, such as for a switch, router, media converter, etc., to a fiber optic or copper networking cable. Furthermore, SFP transceivers may be designed to support various protocols, such as SONET, Gigabit Ethernet, and other communications standards. The SFP transceivers may use SFP+, supporting data rates up to 10.0 Gbit/s and include the data rates for 10 GbE. In addition, this disclosure may relate to other hot-swappable, protocol-independent optical transceivers, such as for example XFPs and XENPACKs.

As noted above, once a conventional pluggable optics device is installed (or deployed) only a small portion of that device remains exposed to the user, and any identification labeling detailing the properties of the device is no longer visible. However, visual indication of the device's properties and characteristics may be achieved through the use of a standardized coloring scheme and/or specific markings (e.g., stripes, dots, etc.) displayed on an exposed surface of the pluggable device. As will be described in greater details below, these properties may include, but are not limited to, information related to the rate, reach and wavelength used by a given pluggable device when that device is in use. It should be noted that the visualization of the operating properties of a pluggable optics device may be accomplished through any number of ways in which each specific property corresponds to a unique color scheme and/or patterned scheme.

The exemplary system for visual identification of pluggable optics may provide substantial operational advantages. Specifically, the exemplary system allows for a user to identify significant characteristics of a deployed pluggable optics device without the need to remove the device from service. Furthermore, the exemplary system may also eliminate the need for the use of software programs when identifying the device. Accordingly, this exemplary quick identification system may expedite any troubleshooting scenarios. In addition, the system may prevent outages that have now become necessary with conventional methods of identifying deployed pluggable devices.

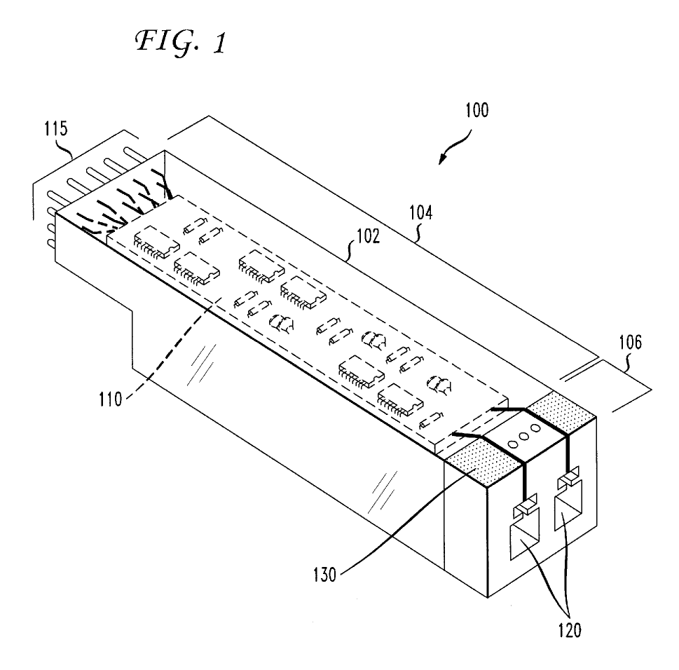

FIG. 1 shows an exemplary assembly 100 for standardized identification of pluggable optics. However, it should be noted that the assembly 100 is not limited to a particular set of included components, and may include any number of components, either more or less than those illustrated in FIG. 1.

The assembly 100 may be described as a pluggable transceiver (e.g., a small form-factor pluggable, or “SFP”) used for telecommunication applications, as well as data communication applications. The assembly 100 may provide an optical interface to a host device, such as a switch, a router, a media converter, etc. Specifically, the assembly 100 may be attached to a network device motherboard to allow the network device to attach to a fiber optic cable. Alternatively, the assembly 100 may allow the device to attach to a copper networking cable interface used by host devices designed primarily for optical fiber communications over unshielded twisted-pair networking cabling.

The assembly 100 may be device to support any number of communication standards, such as, for example, Gigabit Ethernet (e.g., 10 GbE), synchronous optical networking (“SONET”), synchronous digital hierarchy (“SDH”), Fibre Channel, etc. Therefore, the use of any of these communication standards may provide the assembly 100 with the capability to support varying rates of data transmission.

The assembly 100 may be designed with a variety of different transmitter characteristics (e.g., rate, reach, wavelength, etc.) and receiver types (e.g., multi-mode fiber, single-mode fiber, etc.). Each of these variations may allow for the user to select an appropriate transceiver configuration in order to provide preferred optical characteristics over an available optical fiber type.

The assembly 100 may include a housing 102 having an inserted portion 104 and an exposed portion 106. It should be noted that the exposed portion 106 may protrude from the face of a host device (e.g., from a circuit pack) and may represent a very small proportion of the housing 102. The housing 102 of the assembly 100 may be a single-body construction (e.g., formed of a single sheet of metal). Alternatively, the housing 102 may consist of multiple components soldered together, such as multiple pieces of die cast metal. The housing 102 may be constructed from a metal alloy such as, steel, copper, or any other metal having strong electrical conductivity. Furthermore, the housing 102 may include any number of plating options (e.g., tin, lead, nickel, etc.).

A printed circuit board 110 may be attached to or within the housing 102, wherein the printed circuit board 110 may include one or more electrical contacts 115 attached to the inserted portion 104 to provide an electrical connection between the assembly 100 and a host device (e.g., a device receiving the assembly 100). Specifically, the printed circuit board 110 may connect with various electrical contacts 115, such as, ground contacts, power contacts, signal contacts, etc. Therefore, data signals may be transferred between the assembly 100 and the host device. The contacts 115 for connecting the printed circuit board 110 may include a variety of plating options in order to meet performance requirements for the assembly 100. Additional components within the printed circuit board 110 may include passive components such as capacitors and resistors for passing the signals without materially changing the signals. The printed circuit board 110 may also include active components for materially altering data signals prior to transmission.

The assembly 100 may further include one or more optical contacts 120 (e.g., optical receptacles) connected to the printed circuit board 110 and attached to the exposed portion 106 providing an optical connection between the assembly 100 and a received optical component (e.g., a device or cable plugged into the assembly 100). Specifically, the optical contacts 120 may include recesses for mounting optical electronic components within the assembly 100. The optical contacts 120 may constructed from insulating materials, such as plastics, or alternatively, from conductive materials, such as metals, conductively coated plastics, plastics with conductive fillers, etc.

The assembly 100 may further include one or more visual indicators 130 displayed on the exposed portion 106 of the assembly 100. According to one embodiment, the visual indicators 130 may be a color-coded and/or pattern-coded bail on the exposed portion 106 for external visual identification of the one or more characteristics of the assembly 100. This bail including labeling information as well as modifications, such as a sliding tab for altering the displayed code. As will be described in greater detail below, the visual indicator 130 may include any number of patterns, markings, colors, combinations, etc. in order to provide a visual representation at least one characteristic of the assembly 100.

It should be noted that the assembly 100 may include characteristic information on a housing label of the inserted portion 104 of the assembly. These housing labels may include information such as manufacturer, part name/serial number, regulatory agency compliance insignia, etc. However, it is important to note this housing label would not be visible to a user while the assembly 100 is inserted within the host device. Accordingly, the visual indicators 130 on the exposed portion 106 of the assembly 100 may serve as a quick reference to users as to the properties and characteristics of the assembly 100. As noted above, the operational advantages of the visual indicators 130 will allow users of pluggable optics devices, such as the assembly 100, to identify any of these characteristics without removing the assembly 100 from the host device.

The types of visual indicators 130 may include any one of, or combination of, colors (e.g., bail colors), markings, patterns, dots, stripes, hash marks, alphanumeric characters, etc. Furthermore, the type of characteristics identified by the visual indicators 130 may include, but are not limited to, one or more of transmitter wavelength, optical reach (maximum distance), data transmission rate, optical mode/interface (multi-mode, single-mode), average launch power, receiver saturation, receiver sensitivity, etc.

For example, various colors may be designated by the visual indicators 130 to correspond to different transmitter wavelength, or ranges of wavelengths. According to this example, black may denote 1260-1280 nm, blue may denote 1280-1300 nm, gray may denote 1300-1320 nm, green may denote 1320-1340 nm, etc. It is important to note that any of the other characteristics may be designated by the color scheme of the visual indicators 130, and using color to denote wavelength ranges and the specific colors used are for merely illustrating one exemplary embodiment of the assembly 100. For instance, in the alternative, the rate of data transmission may be determined by the various colors of the visual indicators1 130. According to this example, black may denote a rate of 4 Gbs, blue may denote a rate of 8 Gbs, gray may denote 10 Gbs, etc.

In addition, according to one exemplary embodiment of the assembly 100, stripes on the visual indicators 130 may be used in conjunction with the colors to correspond to different optical reaches, or ranges of maximum distances. For example, a single stripe may denote a short reach (e.g., 2 km), a double stripe may denote an intermediate reach (e.g., 15 km), and a triple stripe may denote a long reach (e.g., 40 km). As noted above any of the other characteristics may be designated by the stripe scheme of the visual indicators 130. For instance, in the alternative, the various numbers of stripes on the visual indicators 130 may be used to determine the transmitter wavelength.

It should be noted that there may also be information regarding the one or more protocols supported by the pluggable optics device (e.g., the assembly 100). For instance, it would be very helpful to communicate to a use if, for example, the assembly 100 can support Gigabit Ethernet, Fibre Channel, SONET or some combination of thereof. Accordingly, any number of visual indicators 130 (e.g., color codes, pattern codes, etc.) may be used within the exposed portion 106 in order to represent the various protocols supported by the device.

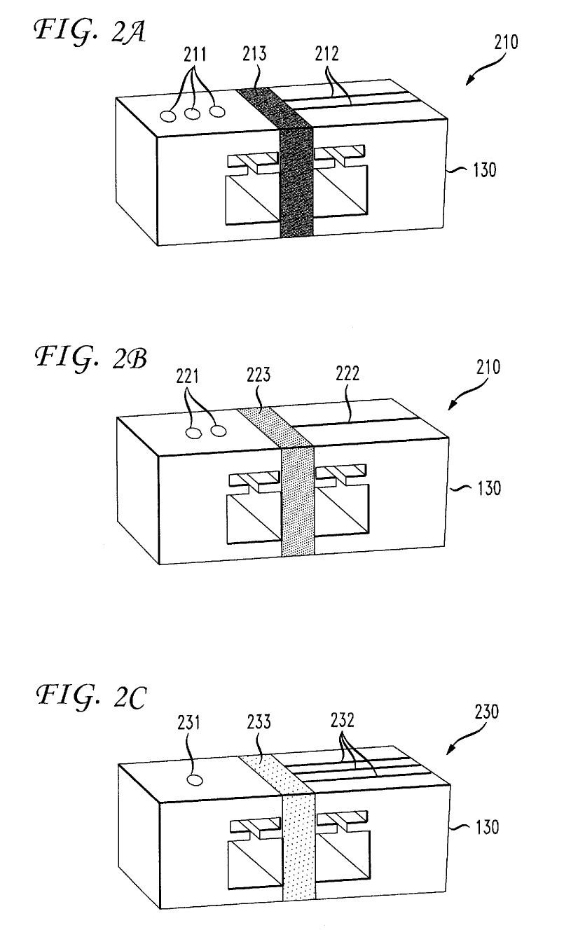

In addition, according to this example, dots on the visual indicators 130 may be used in conjunction with the colors and the stripes to indicate the rate of data transmission of the assembly 100. For example, a single dot may denote a rate of 4 Gbs, a double dot may denote a rate of 8 Gbs, a triple dot may denote a rate of 10 Gbs, etc. For illustrative purposes, these exemplary visual indications 130 are described in greater detail below, with reference to FIGS. 2A-2C.

FIG. 2A show one of the various configurations 210 for the visual indicators 130 of a pluggable optics device, such as assembly 100. For example, the characteristics of the assembly 100 according to configuration 210 may include a transmission rate of 10 Gbs, an intermediate optical reach (e.g., about 15 km), and a transmitter wavelength of 1260-1280 nm. Specifically, the triple dot 211 may denote the 10 Gbs rate; the double stripe 212 may denote the intermediate reach; and the black (e.g., dark shade) color 213 may denote the wavelength range of 1260-1280 nm.

FIG. 2B show another one of the various configurations 220 for the visual indicators 130 of a pluggable optics device, such as assembly 100. For example, the characteristics of the assembly 100 according to configuration 220 may include a transmission rate of 8 Gbs, a short optical reach (e.g., about 2 km), and a transmitter wavelength of 1320-1340 nm. Specifically, the double dot 221 may denote the 8 Gbs rate; the single stripe 222 may denote the short reach; and the gray (e.g., medium shade) color 223 may denote the wavelength range of 1320-1340 nm.

FIG. 2C show a further one of the various configurations 230 for the visual indicators 130 of a pluggable optics device, such as assembly 100. For example, the characteristics of the assembly 100 according to configuration 230 may include a transmission rate of 4 Gbs, a long optical reach (e.g., about 40 km), and a transmitter wavelength of 1300-1320 nm. Specifically, the single dot 231 may denote the 4 Gbs rate; the triple stripe 232 may denote the long reach; and the light-gray (e.g., light shade) color 233 may denote the wavelength range of 1300-1320 nm.

As noted above, the visual indicators 130 of the assembly 100 may be utilized to provide a standardized identification scheme for pluggable optics devices. This standardize scheme may allow users to know specific details and characteristics about the assembly 100 without removing the assembly 100 from service or using software identification techniques. Thus, information regarding the data transmission rate, the optic reach, the transmitter wavelength, etc., of the assembly 100 may be easily obtained by the user at a glance of the exposed portion 106 of the assembly. The standardized scheme may be informative enough to include specific details of the assembly, yet simple enough to allow users to remember the color/pattern coding of the scheme.

It will be apparent to those skilled in the art that various modifications may be made in the described embodiments, without departing from the spirit or the scope of the application. Thus, it is intended that the present disclosure covers modifications and variations of this application provided they come within the scope of the appended claimed and their equivalents.

What is claimed is:

1. An assembly, comprising:
a housing including an inserted portion and an exposed portion;
a printed circuit board attached within the housing;
at least one electrical contact connected to the printed circuit board and attached to the inserted portion providing an electrical connection to a host device;
at least one optical contact connected to the printed circuit board and attached to the exposed portion providing an optical connection to an optical device; and
a visual indicator displayed on the exposed portion representing at least one characteristic of the device.

2. The assembly according to claim 1, wherein the assembly is a small form-factor pluggable transceiver.

3. The assembly according to claim 1, wherein the at least one characteristic is a rate of data transmission.

4. The assembly according to claim 1, wherein the at least one characteristic is an optical reach of the assembly.

5. The assembly according to claim 1, wherein the at least one characteristic is a transmitter wavelength.

6. The assembly according to claim 1, wherein the at least one characteristic is one of an operating optical mode of the assembly and a protocol supported by the assembly.

7. The assembly according to claim 1, wherein the at least one characteristic is one of an average launch power, a receiver saturation, and a receiver sensitivity.

8. The assembly according to claim 1, wherein the visual indicator is a color-coded scheme.

9. The assembly according to claim 1, wherein the visual indicator is a patterned scheme including one of a striped pattern, a dotted pattern, a hashed pattern, a marking pattern, an alphanumeric pattern, and a combination of a color-coded scheme and the patterned scheme.

10. A transceiver system, comprising:
a housing means including an inserted portion and an exposed portion;
an electrical connecting means connecting the inserted portion to a host device;
an optical connecting means connecting the exposed portion to an optical device; and
a visual indicating means on the exposed portion representing at least one characteristic of the device.

11. The transceiver system according to claim 10, wherein the at least one characteristic is a rate of data transmission.

12. The transceiver system according to claim 10, wherein the at least one characteristic is an optical reach of the system.

13. The transceiver system according to claim 10, wherein the at least one characteristic is a transmitter wavelength.

14. The transceiver system according to claim 10, wherein the at least one characteristic is one of an operating optical mode of the system and a protocol supported by the system.

15. The transceiver system according to claim 10, wherein the at least one characteristic is one of an average launch power, a receiver saturation, and a receiver sensitivity.

16. The transceiver system according to claim 10, wherein the visual indicating means is a color-coded scheme.

17. The transceiver system according to claim 10, wherein the visual indicating means is a patterned scheme including one of a striped pattern, a dotted pattern, a hashed pattern, a marking pattern, an alphanumeric pattern, and a combination of a color-coded scheme and the patterned scheme.

18. An optical receptacle, comprising:
an optical contact connecting the optical receptacle to an optical component;
an electrical contact connected the optical receptacle to a pluggable optics device; and
at least one visual indicator including one of a color-coded scheme and a patterned scheme, the at least one visual indicator describing at least one characteristic of the pluggable optics device.

19. The optical receptacle according to claim 18, wherein the at least one characteristic is a rate of data transmission, an optical reach of the receptacle, a transmitter wavelength, an operating optical mode of the receptacle, a protocol supported by the receptacle, an average launch power, a receiver saturation, and a receiver sensitivity.

20. The optical receptacle according to claim 18, wherein the at least one visual indicator includes a color-coded scheme, a striped pattern, a dotted pattern, a hashed pattern, a marking pattern, an alphanumeric pattern, and a combination of a color-coded scheme and a patterned scheme.
